(19) United States
(12) Patent Application Publication
(10) Pub. No.: US 2018/0276032 A1
(43) Pub. Date: Sep. 27, 2018

(54) ELECTRONIC APPARATUS AND CONTROL METHOD THEREOF

(71) Applicant: SAMSUNG ELECTRONICS CO., LTD., Suwon-si (KR)

(72) Inventors: Chang-hyeon CHAE, Suwon-si (KR); Jae-ook KWON, Yongin-si (KR); Ju-sun SONG, Pohang-si (KR); Young-ho CHOI, Suwon-si (KR)

(73) Assignee: SAMSUNG ELECTRONICS CO., LTD., Suwon-si (KR)

(21) Appl. No.: 15/926,750

(22) Filed: Mar. 20, 2018

(30) Foreign Application Priority Data
Mar. 21, 2017 (KR) 10-2017-0035295

(51) Int. Cl. G06F 9/48; G06F 12/02; G06F 21/79

(52) U.S. Cl. CPC G06F 9/485; G06F 21/79; G06F 12/0223

(57) ABSTRACT

An electronic apparatus, in which a memory is efficiently managed, and a control method thereof are provided. The electronic apparatus includes a processor is configured to allocate at least one of a general memory and a kernel memory to a process corresponding to a program in response to execution of the program; calculate a total capacity of the general memory and the kernel memory allocated to each of a plurality of processes; and erase a selected process, among the plurality of processes, which is determined as having a low priority based on the calculated total capacity of the general memory and the kernel memory.

### CROSS-REFERENCE TO RELATED APPLICATION

This application is based on and claims priority under 35 U.S.C. § 119 to Korean Patent Application No. 10-2017-0035295 filed on Mar. 21, 2017 in the Korean Intellectual Property Office, the disclosure of which is incorporated by reference herein in its entirety.

### BACKGROUND

### Field

This disclosure relates to an electronic apparatus and a control method thereof, and more particularly to an electronic apparatus, in which a memory is efficiently managed, and a control method thereof.

### Description of the Related Art

An electronic apparatus may execute various programs.

When an executed program is terminated or switched over to another program, processes corresponding to the executed program may continue to stay resident in memory. This enables the electronic apparatus to quickly start or restart a program with its corresponding resident processes. However, when processes corresponding to a terminated or switched program remain resident in memory the remaining available memory may be insufficient for executing a program.

In the related art, this problem is addressed by erasing, from memory, unnecessary processes to secure the memory.

However, such related art methods of erasing unnecessary processes do not erase the processes based on a memory capacity actually allocated to the processes, and thus have the problem that a desired memory capacity is not secured even after erasing the processes.

Further, in the related art, a user's pattern of using a program is not fully taken into account when erasing processes since the related art methods do not differentiate the priority between a process recently moved to a background in response to switching of execution and processes previously resident in the background.

### SUMMARY

Provided are an electronic apparatus and a control method thereof, in which a process is erased based on a memory actually allocated to the process to thereby efficiently secure the memory.

In accordance with an aspect of the disclosure, there is provided an electronic apparatus including: a processor configured to allocate at least one of a general memory and a kernel memory to a process corresponding to a program in response to execution of the program, calculate a total capacity of the general memory and the kernel memory allocated to each of a plurality of processes, and erase a selected process, from among a plurality of processes, wherein the selected process is determined as having a priority that is low based on the calculated total capacity of the general memory and the kernel memory.

The processor may be further configured to determine the total capacity of the general memory and the kernel memory based on usage of a memory portion dedicated and allocated exclusively to each of the plurality of processes.

The processor may be further configured to determine the priority based on at least one of a state of the process, a use frequency of the process, and whether the process corresponds to a predetermined program.

The processor may be further configured to move the process to a background, and lower a priority of a plurality of processes resident in the background.

The processor may be further configured to calculate a memory portion allocated to at least one process of the plurality of processes resident in the background, and select and erase the process determined as having the priority that is low based on the calculated memory allocated to the at least one process.

The processor may be further configured to classify the plurality of processes into a first group having a first priority and a second group having a second priority that is lower than the first priority with respect to importance, and lower the priority of each of the plurality of processes that belong to the first group and the second group when the process is moved to the background.

In accordance with an aspect of the disclosure, there is provided method of controlling an electronic apparatus, the method including: allocating at least one of a general memory and a kernel memory to a process corresponding to a program in response to execution of the program; calculating a total capacity of the general memory and the kernel memory allocated to each of a plurality of processes; and erasing a selected process, from among the plurality of processes, wherein the selected process is determined as having a priority that is low based on the calculated total capacity of the general memory and the kernel memory.

The erasing of the selected process may include determining the total capacity of the general memory and the kernel memory based on usage of a memory portion dedicated and allocated exclusively to each of the plurality of processes.

The method may further include determining the priority based on at least one of a state of the process, a use frequency of the process, and whether the process is a process of a predetermined program.

The method may further include: moving the process to a background; and lowering a priority of a plurality of processes resident in the background.

The erasing of the selected process may include: calculating a memory portion allocated to at least one of the plurality of processes resident in the background; and selecting and erasing the process determined as having the low priority based on the calculated memory allocated to the at least one of a plurality of processes.

The method may further include: classifying the plurality of processes into a first group having a first priority and a second group having a second priority that is lower than the first priority with respect to importance; and lowering the priority of each of the plurality of processes that belong to the first group and the second group when the process is moved to the background.

In accordance with an aspect of the disclosure, there is provide a computer program product including a computer readable medium having a computer program stored thereon, which, when executed by a computing device, causes the computing device to execute the method.

The computer readable program may be stored in the computer readable storage medium in a server, and the computer program may be downloaded over a network to the computing device.

The computer readable medium may include a buffer memory for downloading of the computer program.

### BRIEF DESCRIPTION OF THE DRAWINGS

The above and other aspects, features and advantages of certain embodiments of the present disclosure will be more apparent from the following description, taken in conjunction with the accompanying drawings, in which:

FIG. 1 illustrates an electronic apparatus according to an embodiment;

FIG. 2 is a block diagram of an electronic apparatus according to an embodiment;

FIG. 3 is a block diagram of a processor according to an embodiment;

FIG. 4 illustrates results of calculating memories allocated to processes according to an embodiment;

FIG. 5 illustrates results of calculating memories allocated to processes according to an embodiment;

FIG. 6 illustrates results of calculating memories allocated to processes according to still an embodiment;

FIG. 7 illustrates an example of changing priorities of other processes when a process is moved to a background according to an embodiment;

FIG. 8 illustrates an example of classifying processes into a plurality of groups and changing priorities of other processes in a group when a process is moved to the group according to an embodiment; and

FIG. 9 is a control flowchart of the electronic apparatus according to an embodiment.

### DETAILED DESCRIPTION

Hereinafter, embodiments will be described in detail with reference to accompanying drawings. Elements in the accompanying drawings will be referred to in the following descriptions of the embodiments, in which like reference numerals or symbols refer to elements having like functions throughout the drawings.

It will be understood that, although the terms first, second, etc. may be used herein to describe various elements, these elements should not be limited by these terms. These terms are only used to distinguish one element from another. The terms set forth herein are just used for describing the embodiments, and not construed as limiting the present disclosure.

As used herein, expressions such as “at least one of” or “at least one from among,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

As used herein, the terms “first” and “second” may use corresponding components regardless of importance or order and are used to distinguish one component from another without limiting the components.

The description of following embodiments may be also applied to electronic apparatuses having various functions.

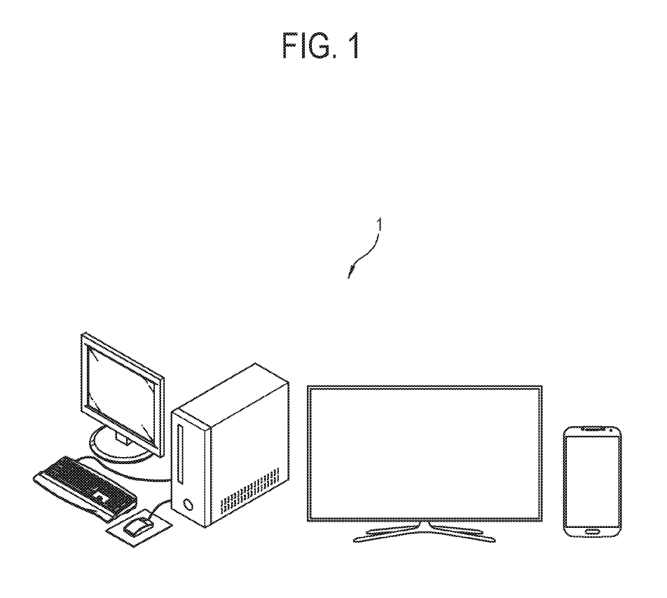

FIG. 1 shows an electronic apparatus according to an embodiment. In some embodiments, the electronic apparatus 1 may be a computer, a TV, a smart phone, or other similar device. As an alternative embodiment, the electronic apparatus 1 may be various apparatuses capable of receiving a network signal and providing contents of the received signal, such as, without limitation, a tablet PC, a multimedia player, an electronic frame, a digital billboard, a digital signage, a large format display (LFD), a set-top box, a smart watch, a refrigerator. However, the electronic apparatus 1 according to embodiments is not limited to these examples.

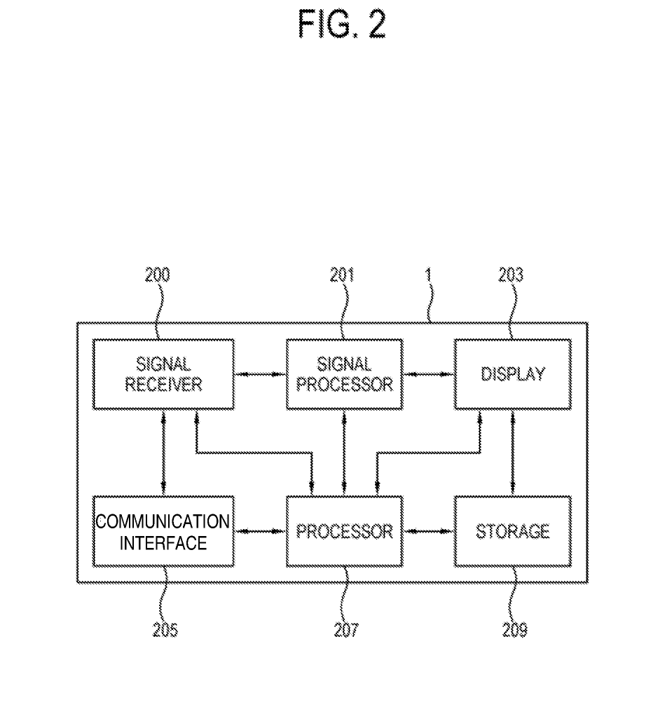

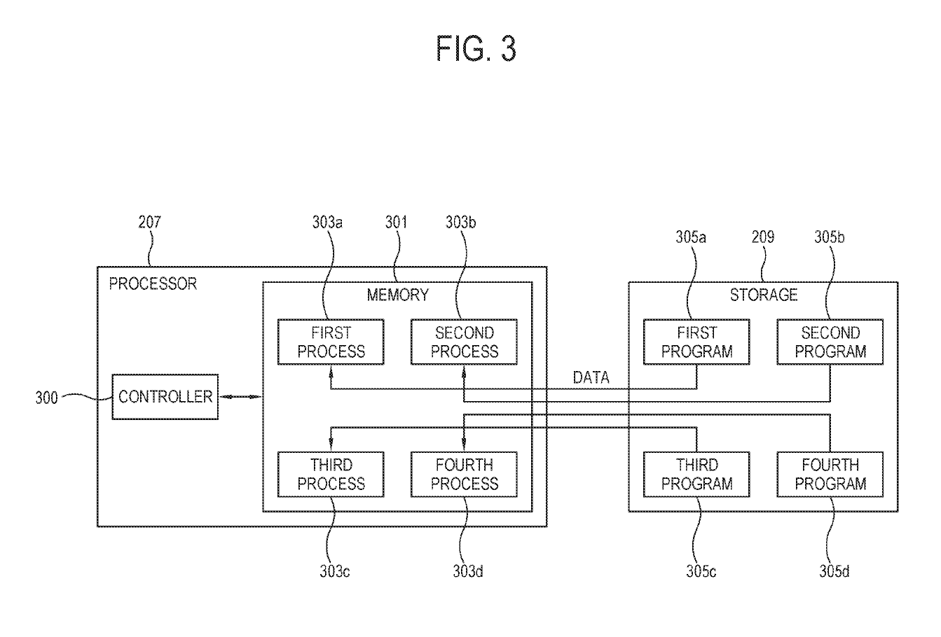

The electronic apparatus 1, according to an embodiment, is controlled, by a program such as a first program 305a, a second program 305b, a third program 305c and a fourth program 305d (collectively referred to as “programs 305”) stored in a storage 209 and a processor 207, to operate in response to commands. The processor 207 (see FIG. 2) includes a memory 301 in which a first process 303a, a second process 303b, a third process 303c and a fourth process 303d (collectively referred to as “processes 303”), each corresponding respectively to the first program 305a, the second program 305b, the third program 305c and the fourth program 305d (see FIG. 3), are temporarily stored. When one of the programs 305 is executed in response to a command, a controller 300 of the processor 207 loads the corresponding process 303 into the memory 301 based on data 306 corresponding to the executed program 305. The processor 207 allocates a partial storage space of the memory 301 to the process 303 loaded into the memory 301. This will be also referred to as ‘allocating the memory’ for convenience of description.

Then, the processor 207 erases at least one process selected from among the plurality of processes 303 when a predetermined condition is satisfied, for example, when the available memory 301 is insufficient, or when a command for securing a portion or part of the memory 301 is received. The selection of the process to be erased from among the processes 303 is determined in accordance with the relative priorities between the processes 303. That is, the processor 207 selects a process from among the processes 303 that has a relatively low priority as the process to be erased. The priority of the selected process 303 may, for example, be determined based on an importance of the process 303, such as, a frequency of performing the process 303, an order of the process 303, and a use of the memory allocated to the process 303.

FIG. 2 is a block diagram of an electronic apparatus according to an embodiment the electronic apparatus. According to an embodiment the electronic apparatus 1 includes a signal receiver 200, a signal processor 201, a display 203, a communication interface 205, a storage 209, and the processor 207. The electronic apparatus 1 according to an embodiment is given by way of example in FIG. 2, and may include another element in addition to those shown in FIG. 2 or exclude an element from those shown in FIG. 2.

The signal receiver 200 receives a signal of content from an external source. The received signal of content includes a broadcast signal. The signal receiver 200 may include a tuner to receive the broadcast signal from a broadcast signal transmitter or a broadcast signal relay. The tuner may be tuned to one channel selected by a user from among a plurality of channels and may receive a broadcast signal through the tuned channel. The signal receiver 200 may also receive a signal of content from a server through a network.

As described above, the electronic apparatus 1 may be a cellular phone, a smart phone, a tablet PC or other mobile apparatus. When the electronic apparatus 1 is a mobile apparatus, the electronic apparatus 1 may additionally include a mobile communication interface that connects with an external apparatus through mobile communication. The mobile communication interface communicates with at least one external apparatus having an antenna and transmits/receives a wireless signal for a voice call, a video call, a text message or a multimedia message.

The signal processor 201 performs signal processing with regard to a signal of content received through the signal receiver 200, and outputs the processed signal to the display 203 so that the display 203 can display an output image of the processed signal thereon. The signal processing performed by the signal processor 201 may, for example, include demultiplexing for dividing the signal including video and audio content into sub-streams of video, audio and appended data; de-interlacing for converting an interlaced video signal into a progressive signal; scaling for adjusting a resolution of a video signal; noise reduction for improving image quality; detail enhancement, frame refresh rate conversion; and other types of signal processing.

The display 203 displays an image of content based on the signal processed by the signal processor 201. The display 203 may include, for example and without limitation, a liquid crystal display, a plasma display, a light-emitting diode (LED) display, an organic light-emitting diode (OLED) display, a surface-conduction electron-emitter display, a carbon nano-tube display, nano-crystal display.

When the display 203 is a liquid crystal display, the display 203 includes a liquid crystal display (LCD) panel, a backlight unit for emitting light to the liquid crystal display panel, a panel driving substrate for driving the liquid crystal display panel. Alternatively, the display 203 may include a self-emissive OLED without the backlight unit.

The communication interface 205 includes a connector for wired communication and may transmit/receive a signal/data in accordance with various standards, such as, without limitation, high definition multimedia interface (HDMI), high definition multimedia interface consumer electronics control (HDMI-CEC), universal serial bus (USB), Component. To this end, the communication interface 205 may include one or more connectors or terminals that correspond respectively to the aforementioned standards. The communication interface 205 may perform wired communication with a plurality of servers through a wired local area network (LAN).

Besides using the connector or terminals for performing wired communication, the communication interface 205 may also perform various other types of communications. For example, the communication interface 205 may perform wireless communication or wireless short-range communication through a wireless LAN. To perform wireless communication with an external apparatus, the communication interface 205 may include, for example and without limitation, a radio frequency (RF) circuit for transmitting/receiving an RF signal, and may be configured to perform one or more communications based on, for example and without limitation Wi-Fi, Bluetooth, Zigbee), Ultra-Wide Band (UWB), wireless USB, near field communication (NFC), infrared data association (IrDA).

The storage 209 of the electronic apparatus 1 is configured to store various data. In such an embodiment, the storage 209 may be a flash memory, an erasable programmable read only memory (EPROM), an electrically erasable programmable read only memory (EEPROM), or other nonvolatile memory.

The processor 207 controls the operation of general elements of the electronic apparatus 1. The processor 207 includes the volatile memory 310 into which at least a part of the program is loaded when the program is started. The memory 301 loads the data of the program 305 (see FIG. 3). The memory 301 is allocated to one or more processors 207 corresponding to the programs 35 under control of the controller 300. The processor 207 may include a microprocessor, a central processing unit (CPU), and other sub processors for controlling operation of the memory 301.

Control programs for operating the processor 207 may include a program(s) given in the form of at least one of a basic input/output system (BIOS), a device driver, an operating system, firmware, a platform and an application program. According to an embodiment, the application program may be previously installed or stored in the electronic apparatus 1 when the electronic apparatus 1 is manufactured, or installed in the electronic apparatus 1 based on corresponding data of the application program received from the outside in the future when it is used. The corresponding data of the application program may, for example, be downloaded from an external server, such as, an application market, to the electronic apparatus 1.

According to an embodiment, the processor 207 may control execution of the program 305 by partially allocate one or more portions of the memory 301 to the processes 303 corresponding to the programs 305 in response to execution of the programs 305. If it is determined that there is a need for securing additional portions of the memory 301 for execution of the programs 305, the processor 207 calculates a usage of the portions of memory 301 allocated to the processes 303 corresponding to the programs 305 that are determined as having a low priority in importance. Here, the priority in importance of the processes 303 may be determined based on the frequency of usage of the processes 303 , the state of the process, and whether the processes 303 correspond to an important specific program. Then, the processor 207 selectively erases the process 303 based on the determined priority in importance to thereby secure additional portions of the memory 301. According to an embodiment, the usage of the memory 301 allocated to the processes 303 determined as having a low priority in importance is calculated, but there are no limitations to the processing order. For example, the priority in importance of the process 303 may be determined after calculating the usage of the memory 301.

The processor 207 secures additional portions of the memory 301 periodically; in response to a memory securing command issued by a user; or when the memory 301 is insufficient to be allocated to the process 303 of the program 305 to be newly executed.

The processor 207 may erase at least one of the processes 303 based on the usage of the memory 301 allocated to the process 303 of the program 305 to be executed.

Below, operations of the processor 207 will be described in detail with reference to the accompanying drawings.

FIG. 3 is a block diagram of a processor 207 according to an embodiment. The processor 207 includes the memory 301 and the controller 300. The controller 300 may manage and control operations of the memory 301. The memory 301 includes a general memory region to which general processes are allocated, and a kernel memory region to which an operating system and the kernel are allocated. Each of the general and kernel memory regions may be concentrated in a certain storage space of the memory 301 or distributed across multiple storage spaces of the memory 301. According to an embodiment, the controller 300 may allocate a spare portion of the kernel memory region except for a portion that is already allocated to the operating system for a general process. The one or more at least one process 303 corresponding to the program 305 is allocated to the memory 301. The process 303 may share a part of the memory 301 allocated thereto with other processes 303. The sharing of a part of the memory 301 may be, for example, based on a time-sharing system. In such a case, when a resident process that is shared is erased, the shared memory 301 is not secured.

In the case of the program 305 being terminated, the corresponding process 303 allocated to the memory 301 is retained until it is erased from the memory 301. The corresponding process 303 of the terminated program 305 is moved to the background of the memory 301. FIG. 3 shows an example in which the memory 301 integrates with the processor 207, but embodiments are not limited thereto. Alternatively, the memory 301 may be provided separately from the processor 207.

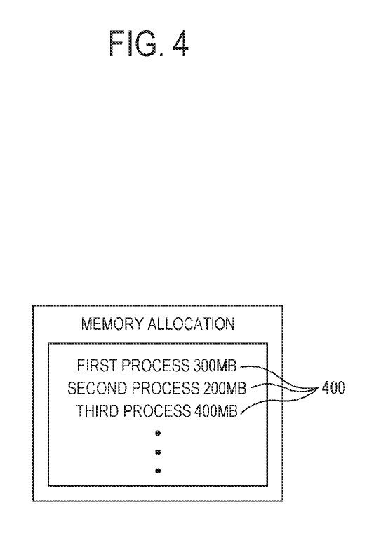

FIG. 4 shows results of calculating memories allocated to processes 303 according to another embodiment.

To secure the memory 301, the controller 300 first calculates the memory 301 allocated to the processes 303 corresponding to a program 305. According to an embodiment, only the usage of the memory 301 allocated to at least one process 303 having a low priority in importance may be calculated. The controller 300 may have an access to a file having information about the memory 301 according to the processes 303 in ‘/proc file system’ to calculate the usage of the memories 301 respectively allocated to the processes 303. An example of the file having the memory information is ‘/proc/PID/statm’.

FIG. 4 shows values 400 resulting from calculating the usage of the memory 301 allocated to each process 303 by the controller 300. The calculated values 400 may be provided to a user through a user interface (UI). The controller 300 may calculate a total size of the processes 303 that are actually mapped to the memory 301 by summing the usage of the memory 301 shared with other processes 303. The summed value is also referred to as a resident set size (RSS). Alternatively, the controller 300 may calculate the value 400 by dividing a private memory of the process 303 and shared memory, which is shared with other processes 303, by the number of processes 303. This is also referred to as a proportional set size (PPS).

The controller 300 may determine that the process 303 to which more memory is allocated has a higher priority of erasing the process 303. That is, when the plurality of processes 303 have the same priority in importance, the controller 300 may select and erase the at least one process 303 to which the most memory is allocated. According to this embodiment, a highest memory value is allocated to a third process, and the controller 300 erases the third process.

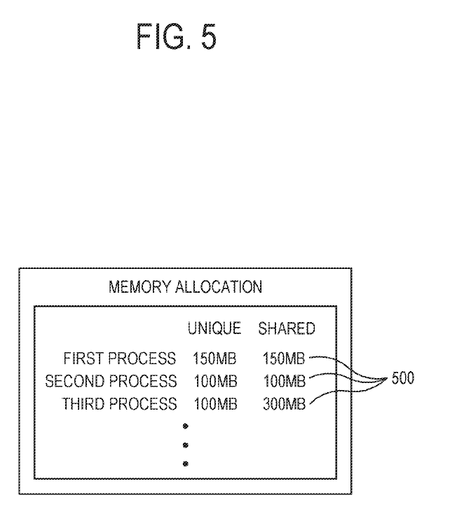

FIG. 5 shows results of calculating usage of memories 301 allocated to the processes 303 according to an embodiment. As shown in FIG. 5, the values 500 obtained by calculating usage of memories 301 allocated to the processes 303. Each calculated value 500 is distinguishably displayed as a unique memory value allocated to each process 303 and a shared memory value shared with other processes 303. The unique memory value is not a value shared with other processes 303, and is also referred to as a unique set size (USS) or a private unique size (PUS).

The controller 300 may more accurately determine the usage of the memory 301 that can be secured when the process 303 is erased based on the calculated unique memory value. The controller 300 may first erase the process 303 to which the highest unique memory value is allocated. According to this embodiment, the highest unique memory value is allocated to the first process, and therefore the most memory 301 is actually secured when the first process is erased. The controller 300 erases the first process based on the calculation results.

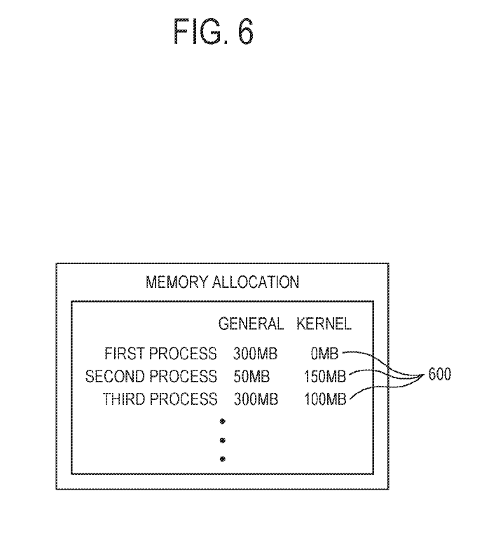

FIG. 6 shows results of calculating usage of the memories 301 allocated to according to still another embodiment. As shown in FIG. 6, the values 600 obtained in the controller 300 by calculating usage of the memories 301 allocated to the processes 303. Each calculated value 600 is divided into a general memory value allocated to a general memory with regard to each process 303, and a kernel memory value allocated to a kernel memory. As described above, the controller 300 may allocate a portion of the kernel memory to the process 303. The controller 300 may determine the process 303 to be erased based on the total memory usage of not only the general memory value allocated to each process 303 but also the kernel memory value.

According to this embodiment, the total sum of the general memory value and the kernel memory value allocated to the third process is highest. Therefore, the controller 300 erases the third process based on the calculation results including not only the general memory value but also the kernel memory value.

The controller 300 may determine the total usage of memory based on overall calculation methods introduced in FIGS. 4 to 6. For example, the controller 300 may employ the unique memory value described with reference to FIG. 5 in determining the total usage of memory described with reference to FIG. 6. That is, the controller 300 may determine the total of general and kernel memory values allocated to a certain process, in consideration of only the unique memory value of the process except a portion shared with other processes.

The controller 300 determines the priority of each process 303 based on the total usage of memory allocated to each process 303 in addition to importance of each process 303, and determines the process 303 to be erased based on the determined priority.

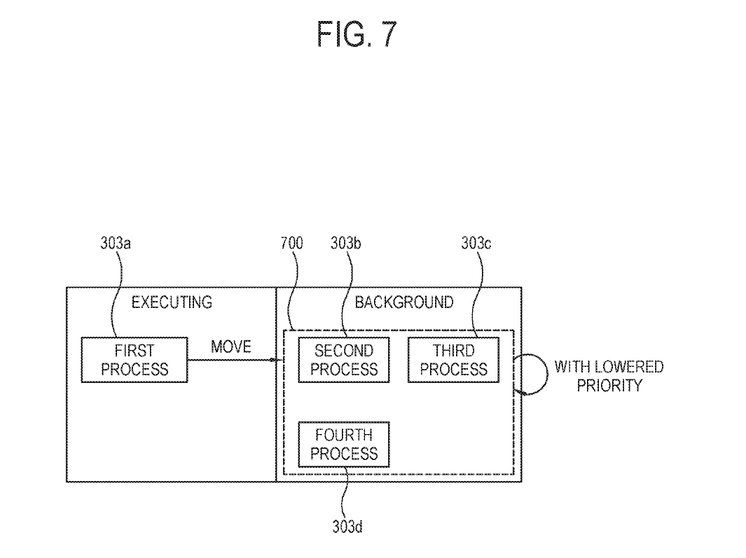

FIG. 7 illustrates an example of changing priorities of other processes when a process is moved to a background according to an embodiment.

When the first program 305a is terminated or another program 305 is executed, the first process 303a corresponding to the first program 305a being executed is moved to the background. When the first process 303a is moved to the background, the controller 300 lowers the priorities of the plurality of processes 700 (i.e. the second process 303b, the third process 303c and the fourth process 303d) previously resident in the background as compared with the priority of the first process 303a.

According to this embodiment, the first process 303a that is recently moved to the background has the highest priority, and thus not the first process 303a but the existing processes 700 are erased. Thus, when the first program 305a that was recently terminated is resumed, a response speed of executing the first program 305a is improved since the first process 303a is retained.

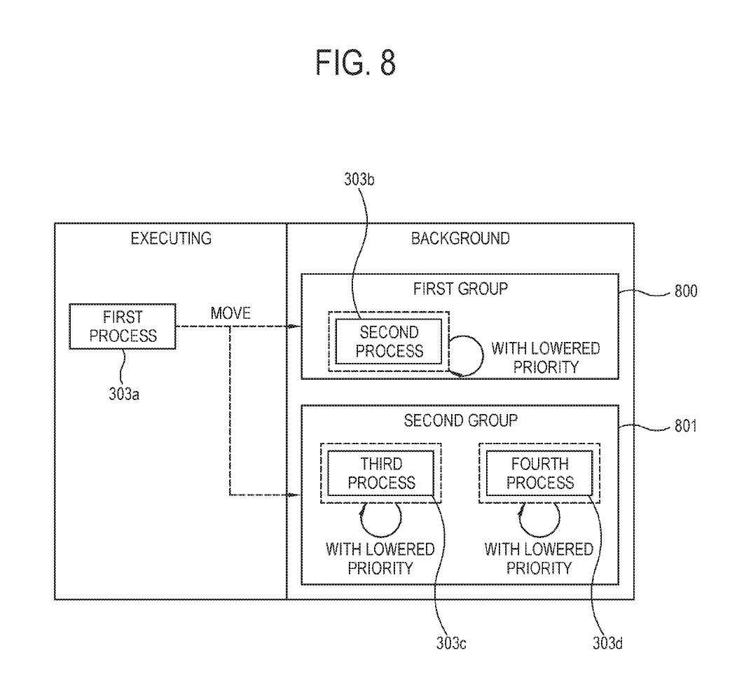

FIG. 8 illustrates an example of classifying processes into a plurality of groups and changing priorities of other processes in a group when a process is moved to the group according to an embodiment.

The plurality of processes 303 may be classified into a plurality of the groups, i.e. the first group 800 and the second group 801 with respect to importance based on a use frequency and the like. In this embodiment, the processes having a use frequency higher than a predetermined frequency are classified into the first group 800 and the processes having a user frequency lower than the predetermined frequency are classified into the second group 801. Each of the first and second groups 800 and 801 may be set to make the first group 800 have a relatively high priority and the second group 801 have a relatively low priority in accordance with their use frequencies. When the first process 303a is moved to the background, it is moved to one of the previously classified first and second groups 800 and 801. When the first process 303a is moved to the background, the controller 300 lowers both the priority of the existing process (i.e., the second process 303b) in the first group 800 and the priorities of the existing processes (i.e., the third process 303c and fourth process 303d) in the second group 801, as compared with the priority of the first process 303a. Therefore, the priority of the first process 303a is kept higher than the priorities of the existing processes in the first and second groups 800 and 801 regardless of whether the first process 303a is moved to the first group 800 having a relatively high priority or the second group 801 having a relatively low priority. Like this, the priorities of the existing other processes 303 are lowered as compared with the recently used process 303, and thus the process 303 recently switched in use is kept to have high priority, thereby improving a response speed when the process 303 is resumed. Further, the process not used for a relatively long time is erased, and the memory is systematically stably secured since the erased process is less likely to be resumed.

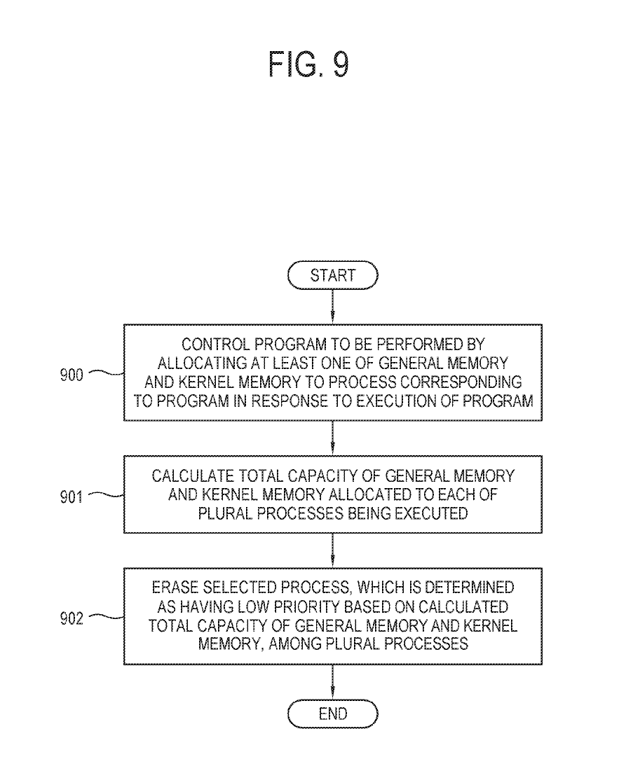

FIG. 9 is a control flowchart of the electronic apparatus according to an embodiment. First, at operation S900, the processor 207 controls a program 305 to be performed by allocating at least one between the general memory and the kernel memory to a process 303 corresponding to a program 305 in response to execution of the program 305. Then, at operation 5901, the processor 207 calculates the total capacity of general and kernel memories allocated to the plurality of processes 303. Next, at operation 5902, the processor 207 selects and erases the process 303, which is determined as having the low priority based on the calculated total capacity of general and kernel memories, among the plurality of processes 303.

As described above, according to embodiments, the process is erased based on the memory allocated to the process, thereby more efficiently securing the memory.

Although a few embodiments have been shown and described, it will be appreciated by those skilled in the art that changes may be made in these embodiments without departing from the principles and spirit of the disclosure, the scope of which is defined in the appended claims and their equivalents.

What is claimed is:

1. An electronic apparatus comprising:
a processor configured to:
allocate at least one of a general memory and a kernel memory to a process corresponding to a program in response to execution of the program,
calculate a total capacity of the general memory and the kernel memory allocated to each of a plurality of processes, and
erase a selected process, from among a plurality of processes, wherein the selected process is determined as having a priority that is low based on the calculated total capacity of the general memory and the kernel memory.

2. The electronic apparatus according to claim 1, wherein the processor is further configured to determine the total capacity of the general memory and the kernel memory based on usage of a memory portion dedicated and allocated exclusively to each of the plurality of processes.

3. The electronic apparatus according to claim 1, wherein the processor is further configured to determine the priority based on at least one of a state of the process, a use frequency of the process, and whether the process corresponds to a predetermined program.

4. The electronic apparatus according to claim 1, wherein the processor is further configured to move the process to a background, and lower a priority of a plurality of processes resident in the background.

5. The electronic apparatus according to claim 4, wherein the processor is further configured to calculate a memory portion allocated to at least one process of the plurality of processes resident in the background, and select and erase the process determined as having the priority that is low based on the calculated memory allocated to the at least one process.

6. The electronic apparatus according to claim 4, wherein the processor is further configured to classify the plurality of processes into a first group having a first priority and a second group having a second priority that is lower than the first priority with respect to importance, and lower the priority of each of the plurality of processes that belong to the first group and the second group when the process is moved to the background.

7. A method of controlling an electronic apparatus, the method comprising:
allocating at least one of a general memory and a kernel memory to a process corresponding to a program in response to execution of the program;
calculating a total capacity of the general memory and the kernel memory allocated to each of a plurality of processes; and
erasing a selected process, from among the plurality of processes, wherein the selected process is determined as having a priority that is low based on the calculated total capacity of the general memory and the kernel memory.

8. The method according to claim 7, wherein the erasing of the selected process comprises determining the total capacity of the general memory and the kernel memory based on usage of a memory portion dedicated and allocated exclusively to each of the plurality of processes.

9. The method according to claim 7, further comprising determining the priority based on at least one of a state of the process, a use frequency of the process, and whether the process is a process of a predetermined program.

10. The method according to claim 7, further comprising:
moving the process to a background; and
lowering a priority of a plurality of processes resident in the background.

11. The method according to claim 10, wherein the erasing of the selected process comprises:
calculating a memory portion allocated to at least one of the plurality of processes resident in the background; and
selecting and erasing the process determined as having the low priority based on the calculated memory allocated to the at least one of a plurality of processes.

12. The method according to claim 10, further comprising:
classifying the plurality of processes into a first group having a first priority and a second group having a second priority that is lower than the first priority with respect to importance; and
lowering the priority of each of the plurality of processes that belong to the first group and the second group when the process is moved to the background.

13. A computer program product comprising a computer readable medium having a computer program stored thereon, which, when executed by a computing device, causes the computing device to execute the method according to claim 8.

14. The computer program product of claim 13, wherein the computer readable program is stored in the computer readable storage medium in a server, and the computer program is downloaded over a network to the computing device.

15. The computer program product of claim 13, wherein the computer readable medium comprises a buffer memory for downloading of the computer program.
